(19) United States
(12) Patent Application Publication
(10) Pub. No.: US 2004/0086615 A1
(43) Pub. Date: May 6, 2004

(54) Reduced calorie confectionery compositions

(75) Inventors: Scott D. Johnson, Ephrata, PA (US); Peter W.H.A. de Cock, Keerbergen (BE); Ravi Nana, Munster, IN (US); Gerald R. Schwetlik, Valparaiso, IN (US); Hans Zoerb, River Falls, WI (US)

Correspondence Address: Jeffrey J. Skelton, Cargill, Inc., P. O. Box 5624, Minneapolis, MN, 55440-5624, US

(73) Assignee: Cargill, Inc. & Cerestar Holding BV

(21) Appl. No.: 10/287,459

(22) Filed: Nov. 4, 2002

(51) Int. Cl. A23L 1/236

(52) U.S. Cl. 426/548

(57) ABSTRACT

A confectionery composition that has a relatively low caloric content and includes erythritol and an fructo-oligosaccharide component is disclosed. The composition may also include isomalt, polydextrose and/or a high protein material. The composition generally contains very low levels of sugars, such as sucrose, and preferably is substantially free of sugars altogether. The composition typically includes a sufficient amount of fructo-oligosaccharide (“FOS”) and/or other components to substantially neutralize the cooling effect of erythritol present.

### BACKGROUND

There has been considerable interest in reducing the fat and calorie contents in confectionery products. A number of such efforts have focused on attempts to achieve significant fat and calorie reductions while obtaining flavor, texture, organoleptic and mouth feel properties very similar to, if not identical to those of conventional high fat, high calorie confections.

It is generally known to provide for a sucrose free confectionery composition wherein sucrose is replaced by sorbitol. Other sugar alcohols similar to sorbitol, such as isomalt, lactitol, maltitol, and the like, have been permitted in foodstuffs including sugar-free chocolate compositions. Additionally, edible carbohydrates with lower energy contents than sucrose have been developed which are suitable for inclusion in chocolate. However, it is often difficult to use these edible carbohydrates and/or sugar alcohols to achieve flavor, texture and mouthfeel comparable to that of traditional chocolate. In addition, many polyols used in sugar free confectioneries can have a laxative effect when consumed in quantities between 10-50 grams or higher.

Conventional high fat, high calorie, chocolate or chocolate-based confections typically contain about 30% to 60% by weight sugar, about 10% to 70% by weight cocoa liquor (which contains about 50-55 wt. % cocoa butter and finely ground cocoa bean solids), up to about 20% to 25% by weight added cocoa butter, and small amounts of other ingredients including nuts, fruits and flavoring. Not only do conventional chocolate confections commonly contain roughly 30% to 35% by weight total fat in the form of cocoa butter, such confections are usually high in saturated fats. In many instances, such high concentrations of saturated fats in a confection is considered undesirable in view of the established adverse health effects of saturated fats in food products. Similarly, the combination of the amounts of fats in conventional chocolate confections and the relatively high sugar content of such products results in a product with a relatively high caloric content which is considered undesirable for those on a reduced calorie diet by choice or due to medical necessity.

Accordingly, it would be advantageous to provide a confectionery composition which is preferably substantially free of sucrose, has a lower calorie content than regular sugar-containing chocolate, and yet still provides acceptable flavor, texture and/or mouthfeel similar to conventional chocolate products. The low calorie confectionery composition should preferably also have a lower Taxation effect than conventional sugar free chocolate compositions. It would be desirable to provide for substantially sucrose-free confectionery composition having one or more of these or other advantageous features.

### SUMMARY

The present application relates to a confectionery composition that has a relatively low caloric content and is in many instances suitable for diabetics. The compositions may be used for confectionery products and coatings. In most instances, the composition is substantially free of sucrose (“sucrose-free”) and preferably is substantially free of sugars altogether. In a preferred embodiment, the present confectionery composition contains no more than about 0.5 wt. % sucrose and, more preferably, contains no more than about 0.5 wt. % total monosaccharide and disaccharide components. In addition, the present composition commonly has a high digestive tolerance characterized by reduced laxation (non-laxative under the intended conditions of use). Further, the present composition can include ingredients that have many health benefits such as fiber, which can promote healthful flora in the gut (prebiotic), as well as enhance calcium absorption. Certain embodiments of the present composition may also have a heat of solution that very nearly approximates that of chocolate. For some applications, it may be desirable to formulate the composition so that it is essentially nonglycemic and noninsulinemic.

Edible compositions sweetened with a low-sugar sweetener, such as a combination of erythritol and FOS (and optionally other sweeteners) are provided herein. In many embodiments, the present composition includes a relatively large amount of the low-sugar sweetener. For example, the composition may include at least about 40% of an erythritol/FOS based sweetener. The compositions typically include a sufficient amount of fructo-oligosaccharide (“FOS”) and/or other components to substantially neutralize the cooling effect of erythritol present in the composition. Examples of other ingredients which can at least partially neutralize the cooling effect of erythritol include polydextrose, cocoa solids and certain high protein materials. As employed herein, the term “high protein materials” refers to materials which include at least about 50 wt. % protein.

The compositions may also include additional non-sucrose sweetener(s), such as isomalt. Isomalt is a mixture of two disaccharides, glucose-glucitol and glucose-mannitol. Specifically, isomalt is a hydrogenated isomaltulose consisting of approximately equal parts of the isomers 1-O-.alpha.-D-glucopyranosyl-D-mannitol (1,1-GPM) and 6-O-.alpha.-D-glucopyranosyl-D-sorbitol (1,6-GPS). Commercially obtainable isomalt has been reported to be produced by, in a first step, enzymatically rearranging sucrose to isomaltulose (6-O-.alpha.-D-glucopyranosyl-D-fructose) and subsequently hydrogenating the isomaltulose with hydrogen/Raney nickel (see, e.g., U.S. Pat. No. 6,187,342).

The fat content of the present compositions are generally high, e.g., at least about 25 wt. % of the compositions are fat. Fat contents of about 30 to 45 wt. % are quite common in the present compositions. In some instances, as in ice cream coatings, the fat content of the composition may be even higher, e.g., in the range of about 50 to 60 wt. % fat. In the present compositions, the fat may include cocoa butter, fractionated palm kernel oil, partially hydrogenated palm kernel oil, partially hydrogenated cottenseed oil, partially hydrogenated soybean oil, or a mixture thereof. In most instances, the fractionated palm kernel oil is used (but not necessarily) together with partially hydrogenated palm oil, partially hydrogenated cottonseed oil, and/or partially hydrogenated soybean oil. Cocoa butter is a particularly suitable fat for use in the present composition. In applications where cocoa butter is desirable, palm oil and/or shea oil may be substituted for all or part of the cocoa butter. Furthermore, wherein the present compositions are ice cream coatings, the fat may comprise cocoa butter, coconut oil, soybean oil, partially hydrogenated coconut oil, peanut oil, partially hydrogenated soybean oil, fractionated soybean oil, fractionated palm kernel oil, fractionated shea oil, or a mixture thereof.

In one embodiment, the present composition includes a confectionery composition comprising at least about 25 wt. % fat and at least about 5 wt. % of an erythritol/FOS combination. The erythritol/FOS combination includes erythritol and an FOS component where the FOS component includes at least about 25 wt. % fructo-oligosacchararide having a degree of polymerization greater than 20 and at least about 50 wt. % fructo-oligosaccharide having a degree of polymerization of less than 20.

In another embodiment, the present composition is a confectionery composition which includes at least about 25 wt. % fat and at least about 35 wt. % of an erythritol/FOS combination. The erythritol/FOS combination commonly has an erythritol/FOS weight ratio of about 30:70 to about 70:30. An erythritol/FOS weight ratio is merely the weight ratio of the total amount of erythritol present to the total amount of the FOS component present.

In another embodiment, the present composition is a confectionery composition which includes at least about 25 wt. % fat and at least about 35 wt. % of an erythritol/FOS combination. The erythritol/FOS combination typically includes erythritol and an FOS component which includes at least about 25 wt. % fructo-oligosaccharide having a degree of polymerization greater than 20 and at least about 50 wt. % fructo-oligosaccharide having a degree of polymerization less than 20.

In another embodiment, the present composition is a confectionery composition comprising erythritol, an FOS component, and at least about 25 wt. % fat. The composition preferably has a glycemic and/or an insulinemic index of no more than about 15. Furthermore, the FOS component generally includes at least about 25 wt. % FOS having a degree of polmerization greater than 20 and at least about 50 wt. % FOS having a degree of polymerization less than 20.

In another embodiment, the present composition is a confectionery composition which includes isomalt, erythritol, an FOS component, and at least about 25 wt. % fat, where the total amount of the isomalt, the erythritol, and the FOS component is at least about 30 wt. % of the composition. The FOS component can include at least about 25 wt. % fructo-oligosaccharide having a degree of polymerization greater than 20 and at least about 50 wt. % fructooligosaccharide having a degree of polymerization of less than 20.

In another embodiment, the present composition is a confectionery composition which includes at least about 5 wt. % isomalt, at least about 25 wt. % fat, and at least about 5 wt. % of an erythritol/FOS combination. The erythritol/FOS combination commonly includes at least about 30 wt. % erythritol and at least about 30 wt. % of an FOS component. In such compositions, the FOS component generally includes at least about 25 wt. % fructo-oligosaccharide having a degree of polymerization greater than 20 and at least about 50 wt. % fructooligosaccharide having a degree of polymerization of less than 20.

In another embodiment, the present composition is a chocolate composition that is commonly substantially free of sucrose, and that includes a cocoa component and a sweetener component. The cocoa component typically includes cocoa butter and cocoa solids, e.g., formed by blending cocoa butter and cocoa liquor. The sweetener component includes erythritol and an FOS component. The FOS component commonly includes at least about 25 wt. % fructo-oligosaccharide having a degree of polymerization greater than 20 and at least about 50 wt. % fructo-oligosaccharide having a degree of polymerization less than 20. Quite commonly, the total fat content of such chocolate compositions is about 30 to 45 wt. %, e.g., where the composition includes about 30 to 45 wt. % cocoa butter.

In another embodiment, the present composition is a confectionery composition which includes erythritol, an FOS component, and at least about 25 wt. % fat. The confectionery composition generally has an insulinemic and/or a glycemic index of no more than about 15. The FOS component commonly includes at least about 25 wt. % fructo-oligosaccharide having a degree of polymerization greater than 20 and at least about 50 wt. % fructo-oligosaccharide having a degree of polymerization less than 20.

In another embodiment, the present composition is a sweetening composition including erythritol and an FOS component, wherein the composition has a glycemic and/or an insulinemic index of no more than about 15. The FOS component may include at least about 25 wt. % fructo-oligosaccharide having a DP greater than 20 and at least about 50 wt. % fructo-oligosaccharide having a DP less than 20. In some instances, the sweetening composition may have a glycemic and/or insulinemic index of no more than about 5. The composition may also have about 30 wt. % erythritol and at least about 30 wt. % of the FOS component. The sweetening composition may also include isomalt. In some instances, the composition may have a weight ratio of the erythritol to the FOS component of about 30:70 to about 70:30., The composition may have at least about 5 wt. % of a combination of erythritol and the FOS component, wherein the ratio of the erythritol to the FOS component is about 55:45 to about 40:60 and the composition may have a glycemic and/or insulinemic index of no more than about 5.

Yet another embodiment provides a sweetening composition which includes erythritol and an FOS component, where the FOS component includes at least about 25 wt. % fructo-oligosaccharide having a DP greater than 20 and at least about 50 wt. % fructo-oligosaccharide having a DP less than 20. The composition preferably has a glycemic and/or an insulinemic index of no more than about 15. The sweetening composition may include at least about 30 wt. % erythritol and at least about 30 wt. % of the FOS component.

### DETAILED DESCRIPTION

Erythritol, a four carbon atom sugar alcohol, is a highly crystalline, all natural, non-caloric bulk sweetener. In general, crystalline solids can exhibit either a negative or positive heat of solution when dissolved in water or other solvents. The high negative heat of solution of erythritol has previously hindered its use in sugar-free chocolates, because a strong cooling effect is normally not considered acceptable for a chocolate. By combining erythritol with substances which have a positive heat of solution, the cooling effect can be significantly reduced or, in some instances, even entirely masked off. Substances such as fructo-oligosaccharides, cocoa solids, protein, and polydextrose each have positive heats of solution. Suitable substances with a positive heat of solution which can be blended with erythritol in the present compositions include fructo-oligosaccharides, polydextrose, and proteins such as sodium caseinate. Inulin and related fructo-oligosaccharides are particularly suitable materials for use in offsetting the cooling effect of erythritol. The present erythritol containing compositions may include about 5 to 40 wt. % fructo-oligosaccharides. If polydextrose is included, it may be present in a similar amount. Sufficient high protein materials may be included to provide about 5 to 25 wt. % total protein in the composition. Suitable high protein materials for use in the present composition include casein, whey protein, milk protein, pea protein, soy protein, gelatin, mixtures thereof, and/or processed forms thereof (e.g., hydrolyzed and/or chemically modified protein materials). Examples of such high protein materials include sodium caseinate, calcium caseinate, whey protein isolate, milk protein isolate, whey protein concentrate, milk protein concentrate, pea protein isolate, soy protein isolate, soy protein concentrate, hydrolyzed gelatin, hydrolyzed whey protein isolate, whey, and/or cultured non-fat dried milk. In some instances, the present composition may include sufficient high protein materials to provide at least about 10 wt. % total protein in the composition.

Substances, which have a positive heat of solution, can also be blended with substances which can prevent erythritol from returning into its original crystalline state after solidification of a chocolate. Through the use of a combination of the two techniques, the cooling effect of erythritol can either be significantly reduced (e.g., with milk chocolate) or even entirely masked off (e.g., with dark chocolate). Suitable substances which can prevent erythritol from returning into its original crystalline state after solidification of a chocolate include fats, cocoa liquor, cocoa powder and/or milk (lactose). Such substances may function by either co-crystallizing or competing with the erythritol for the available water during the dissolution process in the mouth. In higher fat content compositions, the fat may coat the erythritol crystals in a manner which lowers the cooling sensation when biting the chocolate. Erythritol appears to be by far more susceptible to this effect as it has a comparatively low water solubility (for example in comparison to other polyols such as maltitol, xylitol or sorbitol). The aforementioned ingredients like lactose (milk), sodium caseinate, polydextrose and fructo-oligosaccharides show higher solubilities and therefore can compete with erythritol for the available water in the mouth.

As more erythritol is added to a food composition, the product will commonly have a stronger cooling effect. To negate that cooling effect, more material with positive heat of solution must be typically added (e.g., FOS, protein, polydextrose and the like). Obviously, in the case of a two component mixture, if one goes up, the other must go down. For example, if the amount of erythritol is increased (higher cooling effect), then the relative amount of fructo-oligosaccharides (“FOS”) will be decreased (less warming effect). In the case of a formula which was a 60:40 blend of erythritol:FOS, the product would have a stronger cooling effect as compared to a similar product made with an erythritol:FOS blend of, for example, 50:50. The higher the percentage erythritol, typically the more noticeable the cooling effect in the mouth will be.

Some polyol sweeteners, such as maltitol may have a laxative effect when ingested in the amounts generally required to sweeten a chocolate (e.g., 10-50 gram quantities). Erythritol, however, is generally non-laxative when ingested in similar amounts in such a composition.

Sucrose-free chocolate with a relatively high erythritol content can commonly be made under the same processing conditions (e.g., conching temperature) as regular chocolate. This is in contrast to sugar-free chocolates sweetened with isomalt/xylitol or lactitol, where conching typically must be carried out at a lower temperature, thereby often affecting the chocolate flavor. Conching is employed for modifying the flavor and improving the rheological characteristics of chocolate. This operation can be carried out in a single stage (liquid conching) or in two stages (dry and then liquid conching) and may last from a few hours to several days. The refined powder is worked at high temperature, typically at around 75 to 80° C. in the case of a dark chocolate, and at around 65° C. for white and milk chocolates. Dry conching consists in performing this high temperature working in the absence of high fat contents and can enable the conching time to be reduced.

Erythritol has a caloric content of only 0.2 kcal/g in contrast to inulin (1 kcal/g), isomalt (2 kcal/g), and sugars such as glucose, fructose, sucrose and lactose (4 kcal/g). Thus, the inclusion of erythritol in confectionery compositions can allow more fat to be added without increasing calories. This can contribute to a better, more sugar-like taste profile. The use of erythritol also can allow the over proportional reduction of artificial sweetener because of the synergistic sweetening power of erythritol with high intensity sweeteners. This will also contribute to a more sugar like and cleaner taste. As erythritol content of a food is increased, the cooling effect as a result of negative heat of solution of erythritol is also increased. As the inulin content of erythritol-containing foods is increased, although it can help to offset the cooling effect of the erythritol, the mouthfeel of the composition may degrade as a result of higher fiber content. Inulin is a fructo-oligosaccharide with a relatively high degree of polymerization (“DP”) and thus a relatively high fiber content. This effect can be ameliorated somewhat by employing an fructo-oligosaccharide with a lower average degree of polymerization, e.g., a fructo-oligosaccharide which includes at least 25 wt. % fructo-oligosaccharide having a DP greater than 20 and at least 50 wt. % fructo-oligosaccharide having a DP less than 20. If a fructo-oligosaccharide with too low a DP is used, although the mouthfeel of the product may generally be quite good, the sugar content may be undesirably high. The inclusion of fructo-oligosaccharide with too low a DP can also contribute to gastric distress as a result of fermentation in the gut. It is also preferable to adjust the amount and DP of the fructo-oligosaccharide so that the total sugar content of the composition remains below about 0.5 wt. %, i.e., so that the composition contains no more than about 0.5 wt. % total monosaccharide and disaccharide components.

The inclusion of cocoa liquor together with fructo-oligosaccharide can allow the elimination of the erythritol cooling effect in many instances. The higher amount of cocoa liquor that is typically employed in dark chocolate compositions for flavor reasons can often serve to aid in countering the cooling effect of erythritol.

Isomalt may also be included is in the present compositions. Isomalt commonly has only a limited impact on cooling effect but is often included as part of a sweetener component due to economic and hedonic purposes.

Fats from a variety of sources may be used in the present confectionery compositions. Typically, the fat is of plant oil origin. The plant oil may be in substantially unaltered form, e.g., the cocoa butter which is obtained from pressing cocoa liquor, or the plant oil may be processed in some manner before being used in the present confectionery compositions. Examples of processed plant oils include fractionated oils from sources and hydrogenated plant oils. As employed herein, the term “hydrogenated plant oils” refers to both partially hydrogenated plant oils and fully hydrogenated plant oils. Cocoa butter is a particularly suitable fat for use in the present composition. In applications where cocoa butter is desirable, palm oil and/or shea oil may be substituted for all or part of the cocoa butter.

The present confectionery compositions may be designed for many uses, such as solid molding, enrobing, and/or formation into drops, chunks, or chips. For such applications, the confectionery composition typically includes a fat such as cocoa butter, fractionated palm kernel oil, partially hydrogenated palm kernel oil, partially hydrogenated cottonseed oil, partially hydrogenated soybean oil, and mixtures thereof. As used throughout this disclosure, the term “hydrogenated oil” is meant to include both partially and fully hydrogenated oil. In most instances, the fractionated palm kernel oil is used together with partially hydrogenated palm oil, partially hydrogenated cottonseed oil, and/or partially hydrogenated soybean oil.

In the instances where the confectionery composition is to be employed as an ice cream coating, the fat may suitably be selected from fats such as cocoa butter, coconut oil, soybean oil, partially hydrogenated coconut oil, peanut oil, partially hydrogenated soybean oil, fractionated soybean oil, fractionated palm kernel oil, fractionated shea oil, and mixtures of such oils.

Erythritol has the lowest molecular weight (122) of all sugar alcohols that are used as a sugar replacer in foods. It is readily absorbed via passive diffusion through the small intestine for more than 90%, the highest absorption rate of all sugar alcohols. The absorbed erythritol is not systemically metabolized and excreted unchanged with the urine. Because of this unique metabolic profile, erythritol is not only nonglycemic and noninsulinemic, it also has the highest digestive tolerance of all sugar alcohols (about 2-3 times higher compared to maltitol). It was also demonstrated in clinical studies that consumption of erythritol does not raise plasma glucose or insulin levels. Mean plasma glucose and insulin levels, measured for up to 3 hours after ingestion of a single dose of 1 g erythritol/kg body wt, were unaffected by erythritol. Both the glycemic index (“GI”) as well as the insulinemic index (“InsI”) of erythritol are essentially zero. The importance of low glycemic and low insulinemic foods is gaining more and more attention because of their potential benefits. These include a lower risk of developing type-2 diabetes, a lower probable risk of a hypoglycemic episode, long-term diabetic complications and coronary heart disease, and helping manage obesity.

A glycemic carbohydrate is measured as total carbohydrate minus dietary fiber, as determined by the AOAC method. Inulin, being a dietary fiber, is nonglycemic and noninsulinemic.

The GI of sucrose is about 70 (glucose=100). However, when using sucrose in chocolate, due to the fat in the chocolate we found that the GI of the sucrose alone decreases to about 30. Such high decrease in GI does not occur with maltitol. The GI of maltitol alone is around 35. When using in chocolate, we found that the GI of maltitol alone only slightly decreases to about 30. One remarkable finding concerns the InsI for both sucrose and maltitol. The InsI increases significantly for both carbohydrates when used in chocolate: for sucrose it increases from 45 to 75, and for maltitol from 30 to 80.

When replacing all maltitol in chocolate with erythritol, or a mixture of erythritol and fructo-oligosaccharides, it was found that the GI did not change and remained zero. Moreover, it was discovered that the InsI did not change either; it did not rise with the inclusion of erythritol as it did with maltitol or sucrose, but instead remained at about zero.

Isomalt has a very low GI of around 10. When introducing isomalt in a chocolate recipe that is based on erythritol only or in a recipe based on erythritol and fructo-oligosaccharides, and the amount of isomalt used is typically maximally 25% of the total recipe (maximally about 50% of the total carbohydrate content), it has been found that the GI of such mixture of carbohydrates is less than 5. Moreover, the introduction of isomalt in such recipe did not increase the InsI either and kept the InsI less than 5.

A food with a GI or InsI lower than 5 are generally accepted to be classified as nonglycemic or noninsulinemic. The present compositions can therefore provide a nonglycemic and noninsulinemic chocolate, for example, which is based on a mixture of erythritol and fructo-oligosaccharides, or on a mixture of erythritol, fructo-oligosaccharides and isomalt, where the isomalt content is kept below 50 wt. % of such mixture.

When present in the present composition, cocoa derived materials such as cocoa liquor and/or cocoa powder typically provide a primary or dominant contribution to the overall flavor profile of the composition. In some instances milk derived materials, such as milk solids, may be included in the composition and will influence the overall flavor profile. For example, in milk flavored compositions, the milk ingredient of the filling provides an important contribution to the overall flavoring profile. The present composition may include a flavoring component other than cocoa and/or milk derived materials. The flavoring component may include other flavoring compositions and oils such as fruit flavorings, chocolate substitutes, nut flavorings or other similar products conventionally used to flavor confections, including water soluble flavorings. In one such embodiment, other flavor components such as caramel flavoring, butter and butter flavorings, and similar flavor modifiers can be used in conjunction with cocoa liquor and hazelnut paste to provide a desired flavor profile for a specific application.

Other components of the composition also may affect the flavor profile of the confection: Thus, the amount of flavoring component used in the filling may be varied depending on the flavor profile desired for the confectionery product and the flavoring contributions of other ingredients of the confection.

In some instances, it may also be advantageous to include a calcium source in the present compositions. It has been reported that foods which include fiber materials, such as fructo-oligosaccharides with a relatively high DP (e.g., an average DP greater than 20), can enhance the absorption of calcium. Examples of suitable materials for inclusion as a calcium source include inorganic calcium salts, such as dicalcium phosphate, tricalcium phosphate, and/or calcium carbonate and calcium salts of proteins, such as calcium caseinate. Where calcium materials are included in the present compositions, they may be present at levels of about 2 to 10 wt. % of the composition.

The present compositions may also include an emulsifier. The inclusion of the emulsifier can aid in incorporating flavoring components into the composition. The inclusion of an emulsifier can also serves both to provide desirable organoleptic, texture and gelling characteristics, and as an important emulsifying component of the mixture used to provide the desired flavor profile to the filling composition. Protein and non-protein emulsifiers may be used depending on the desired properties and application of the composition. Examples of suitable nonprotein emulsifiers include lecithin (e.g., soy lecithin) and glyceryl monostearate.

The texture of the present composition is determined in significant part by the properties of the sweetening component used in its formulation. The texture and mouth feel of the composition also may be modified by the use of food protein and/or food polymer carbohydrates, such as starches, starch maltodextrines, and other starch systems, such as those derived from tapioca, potato, rice and corn products. Various proteins, which may be employed to modify the texture and mouth feel of the composition, include those derived from egg whites, low bloom gelatins, casein, milk protein isolates and milk.

For food safety purposes, preservatives may be added to the product. Examples of suitable preservatives include sorbates and other conventional preservatives. The preservatives are typically used in small amounts so as to not adversely effect the flavor, organoleptic or texture properties of the confectionery product.

### ILLUSTRATIVE EMBODIMENTS

In one embodiment, the present composition includes a confectionery composition comprising at least about 25 wt. % fat and at least about 5 wt. % of an erythritol/FOS combination. The erythritol/FOS combination includes erythritol and an FOS component where the FOS component includes at least about 25 wt. % fructo-oligosacchararide having a degree of polymerization greater than 20 and at least about 50 wt. % fructo-oligosaccharide having a degree of polymerization of less than 20. The erythritol/FOS combination may have an erythritol/fructo-oliggosaccharide weight ratio of about 30:70 to about 70:30. Such compositions may have a glycemic index of no more than about 15 and/or an insulinemic index of no more than about 15. The composition may further include isomalt. Generally, the isomalt is no more than about 50 wt. % of the total amount of the non-fat components present in the composition. The composition may have substantially no cooling effect when eaten. The composition may include a texture and mouth feel enhancer selected from the group consisting of food protein, food polymer carbohydrates, and mixtures thereof. In some instances, such compositions may include about 5-15 wt. % erythritol, about 5-15 wt. % of the FOS component, and about 20-45 wt. % isomalt. The present confectionery composition commonly contains no more than about 0.5 wt. % sucrose and, preferably, contains no more than about 0.5 wt. % total monosaccharide and disaccharide components. In other instances, the composition may include polydextrose and/or a high protein component. The high protein component may include casein, whey protein, milk protein, pea protein, soy protein, gelatin, mixtures thereof, or processed forms thereof. Examples of such high protein materials include sodium caseinate, calcium caseinate, whey protein isolate, milk protein isolate, whey protein concentrate, milk protein concentrate, pea protein isolate, soy protein isolate, hydrolyzed gelatin, hydrolyzed whey protein isolate, whey, and/or cultured non-fat dried milk and mixtures thereof. The composition may also include a calcium source.

In another embodiment, the present composition is a confectionery composition which includes at least about 25 wt. % fat and at least about 35 wt. % of an erythritol/FOS combination. The erythritol/FOS combination commonly has an erythritol/FOS weight ratio of about 30:70 to about 70:30. The erythritol/FOS combination may include an FOS component that has at least about 25 wt. % fructo-oligosaccharide having a DP greater than 20 and at least about 50 wt. % fructo-oligosaccharide having a DP no more than 20. The composition may include about 30 wt. % cocoa liquor. The composition may include about 30 to 45 wt. % cocoa butter. In some instances, such compositions may have a total fat content of about 30 to 45 wt. % and include at least about 15 wt. % cocoa solids. In addition, the composition may have a glycemic and/or an insulinemic index of no more than about 15. The composition may also include polydextrose and/or isomalt.

In another embodiment, the present composition is a confectionery composition which includes at least about 25 wt. % fat and at least about 35 wt. % of an erythritol/FOS combination. The erythritol/FOS combination typically includes erythritol and an FOS component which includes at least about 25 wt. % fructo-oligosaccharide having a degree of polymerization greater than 20 and at least about 50 wt. % fructo-oligosaccharide having a degree of polymerization of less than 20. The composition may have a glycemic and/or an insulinemic index of no more than about 15. The composition can include at least about 10 wt. % erythritol and at least about 10 wt. % of the FOS component. In addition, the composition may have a total fat content of about 30 to 45 wt. % and include at least about 15 wt. % cocoa solids.

In another embodiment, the present composition is a confectionery composition comprising erythritol, an FOS component, and at least about 25 wt. % fat. The composition preferably has a glycemic index of no more than about 15 and/or an insulinemic index of no more than about 15. Furthermore, the FOS component generally includes at least about 25 wt. % fructo-oligosaccharide having a DP greater than 20 and at least about 50 wt. % fructo-oligosaccharide having a DP less than 20. Such a composition may have a glycemic and/or an insulinemic index of no more than about 5. In addition, the composition may include at least about 5 wt. % of a combination of erythritol and the FOS component, where the composition includes the erythritol and the FOS component in a weight ratio of about 70:30 to about 30:70. In some instances, the composition may include at least about 10 wt. % erythritol and at least about 10 wt. % of the FOS component.

In another embodiment, the present composition is a confectionery composition which includes isomalt, erythritol, an FOS component, and at least about 25 wt. % fat, where the total amount of the isomalt, the erythritol, the FOS component is at least about 30 wt. % of the composition. The FOS component can include at least about 25 wt. % fructo-oligosaccharide having a degree of polymerization greater than 20 and at least about 50 wt. % fructooligosaccharide having a degree of polymerization of less than 20. Such compositions may include about 5 wt. % or higher of the combination of erythritol and the FOS component. In addition, the composition may have a glycemic and/or an insulinemic index of no more than about 5. Further, the weight ratio of erythritol to the FOS component may be about 70:30 to about 30:70. Some variations of such compositions may include about 5-15 wt. % erythritol, about 5-15 wt. % of the FOS component, and about 20-45 wt. % isomalt.

In another embodiment, the present composition is a confectionery composition which includes at least about 5 wt. % isomalt, at least about 25 wt. % fat, and at least about 5 wt. % of an erythritol/FOS combination. The erythritol/FOS combination commonly includes at least about 30 wt. % erythritol and at least about 30 wt. % of an FOS component. In such compositions, the FOS component generally includes at least about 25 wt. % fructo-oligosaccharide having a degree of polymerization greater than 20 and at least about 50 wt. % fructooligosaccharide having a degree of polymerization of less than 20. The composition may be a chocolate composition including at least about 30 wt. % cocoa butter. Such a composition may include about 5-15 wt. % erythritol, about 5-15 wt. % of the FOS component, and about 20-45 wt. % isomalt. The composition may have a glycemic and/or an insulinemic index of no more than about 15.

In another embodiment, the present composition is a chocolate composition that is substantially free of sucrose and other sugars (preferably the composition contains less than 0.5 wt. % total sugar content), and includes a cocoa component and a sweetener component. The cocoa component typically includes cocoa butter and cocoa solids, e.g., formed by blending cocoa butter and cocoa liquor. The sweetener component includes erythritol and an FOS component. The FOS component commonly includes at least about 25 wt. % fructooligosaccharide having a degree of polymerization greater than 20 and at least about 50 wt. % fructo-oligosaccharide having a degree of polymerization less than 20. Quite commonly, the total fat content of such chocolate compositions is about 30 to 45 wt. %, e.g., where the composition includes about 30 to 45 wt. % cocoa butter. The composition may also include a milk solids component. In addition, the sweetener component can have an erythritol/FOS weight ratio of about 30:70 to about 70:30. The erythritol component may be greater than about 15 wt. % and the FOS component may be greater than about 15 wt. % of the composition. The composition may include about 30-45 wt. % cocoa butter and more than at least about 15 wt. % cocoa solids. The composition may also have a glycemic and/or an insulinemic index of no more than about 15.

In another embodiment, the present composition is a confectionery composition which includes erythritol, an FOS component, and at least about 25 wt. % fat. The confectionery composition generally has an insulinemic and/or a glycemic index of no more than about 15. The FOS component commonly includes at least about 25 wt. % fructo-oligosaccharide having a degree of polymerization greater than 20 and at least about 50 wt. % fructo-oligosaccharide having a degree of polymerization less than 20. In some cases, the composition may have an insulinemic and/or a glycemic index of no more than about 5. In addition, the composition may include at least about 10 wt. % erythritol and at least about 10 wt. % of the FOS component.

Another embodiment provides a sweetening composition which includes erythritol and an FOS component, where the FOS component includes at least about 25 wt. % fructo-oligosaccharide having a DP greater than 20 and at least about 50 wt. % fructo-oligosaccharide having a DP less than 20. The sweetening composition is typically substantially fat-free and can be used to sweeten a wide variety of foodstuffs. The composition preferably has a glycemic and/or an insulinemic index of no more than about 15. The sweetening composition may include at least about 30 wt. % erythritol and at least about 30 wt. % of the FOS component. In some cases, the composition may have an insulinemic and/or a glycemic index of no more than about 5. The composition may have a weight ratio of erythritol to the FOS component of about 30:70 to about 70:30. The composition may include at least about 5 wt. % of a combination of erythritol and the FOS component where the composition has a glycemic and/or an insulinemic index of no more than about 5 and includes the erythritol and the FOS component in a weight ratio of about 55:45 to about 40:60. The composition may include at least about 30 wt. % erythritol and at least about 30 wt. % of the FOS component. The composition may also include isomalt and/or polydextrose. Preferably, the sweetening composition contains no more than about 0.5 wt. % sucrose and, more preferably, contains no more than about 0.5 wt. % total monosaccharide and disaccharide components.

Another embodiment provides a sweetening composition which includes erythritol and an FOS component, where the FOS component includes at least about 25 wt. % fructo-oligosaccharide having a DP greater than 20 and at least about 50 wt. % fructo-oligosaccharide having a DP less than 20. The composition preferably has a glycemic and/or an insulinemic index of no more than about 15. The sweetening composition may include at least about 30 wt. % erythritol and at least about 30 wt. % of the FOS component. In some cases, the composition may have an insulinemic and/or a glycemic index of no more than about 5. Other variations of the composition may include at least about 5 wt. % of a combination of erythritol and the FOS component where the composition has an erythritol/FOS weight ratio of about 55:45 to about 40:60. The composition may also include isomalt. In addition, the composition may have a weight ratio of the erythritol to the FOS component of about 30:70 to about 70:30. Preferably, the sweetening composition contains no more than about 0.5 wt. % sucrose and, more preferably, contains no more than about 0.5 wt. % total monosaccharide and disaccharide components.

Yet another embodiment provides a confectionery composition comprising at least about 25 wt. % fat and at least about 5 wt. % of an erythritol/FOS combination. The erythritol/FOS combination includes erythritol and an FOS component where the FOS component includes at least about 25 wt. % fructo-oliggosaccharide having a degree of polymerization greater than 20 and at least about 50 wt. % fructo-oligosaccharide having a degree of polymerization of less than 20. The erythritol/FOS combination can have an erythritol/fructo-oliggosaccharide weight ratio of about 40:60 to about 55:45. Such confectionery compositions can also have a glycemic index of no more than about 15 and/or an insulinemic index of no more than about 15.

### EXAMPLES

The following examples are presented to illustrate the present invention and to assist one of ordinary skill in making and using the same. The examples are not intended in any way to otherwise limit the scope of the invention.

### Example 1

A low sugar chocolate composition was formed using the following procedure. All dry ingredients were blended together with a portion of the fat (cocoa butter or vegetable oil). The fat at mixing was roughly 28%. In the instances where the product was being supplemented with protein, mixing fat was increased to about 31% since the protein binds a great deal of the liquid fat. A 5 roll refiner was used to reduce particle size of the solids to between 20-30 μm. After refining, the product was heated slightly, given shearing agitation, and the remainder of the fat was added. Lecithin (or a fraction thereof) was added to obtain the proper viscosity, and liquid flavors were also added at this point.

Care must be taken during the process and handling so that temperatures don't exceed 60° C. Should this happen, thermo-visco degradation could occur and the product will commonly thicken in a matter directly proportional to the increase in temperature it is exposed to.

TABLE 1

| | | Wt. % Fat in | |
|---|---|---|---|
| Wt. % Ingredient | Ingredient | Ingredient | Wt. % Fat in Mix |
| 18.03 | Cocoa Liquor | 54 | 9.74 |
| 21.52 | Cocoa Butter | 100 | 21.52 |
| 23.44 | Erythritol | 0 | 0 |
| 11.25 | Inulin F97* | 0 | 0 |
| 11.3 | Inulin LC HT** | 0 | 0 |
| 2.70 | Anhydrous Milk Fat | 99.8 | 2.70 |
| 4.91 | Sodium Caseinate | 1.5 | 0.07 |
| 0.45 | Soya Lecithin | 99.2 | 0.45 |
| 0.03 | Vanillin | 0 | 0 |
| 0.03 | Sucralose | 0 | 0 |
| 5.0 | Calcium Carbonate | 0 | 0 |
| 0.03 | Natural Milk | 0 | 0 |
| | Flavoring | | |
| 0.4 | Mineral Blend | 0 | 0 |
| 1.0 | Natural Chocolate | 0 | 0 |
| | Flavoring | | |

*Inulin F97 is a mixture of fructo-oligosacchararides which includes 70 ± 5% (on DM) fructo-oligosacchararide with a DP less than or equal to 10 and includes 94 ± 5% (on DM) fructo-oligosacchararide with a DP less than or equal to 20.
**Inulin LC HT is a mixture of fructo-oligosacchararides which has an average DP of at least 20 and includes 70% (on DM) fructo-oligosacchararides with a DP greater than or equal to 20.

### Example 2

Another low sugar chocolate composition was formed using the process in Example 1 with the following ingredients:

TABLE 2

| | | Wt. % Fat in | |
|---|---|---|---|
| Wt. % Ingredient | Ingredient | Ingredient | Wt. % Fat in Mix |
| 13.48 | Cocoa Liquor | 54 | 7.28 |
| 24.01 | Cocoa Butter | 100 | 24.0 |
| 23.36 | Erythritol | 0 | 0 |
| 12.35 | Inulin F97 | 0 | 0 |
| 12.35 | Inulin LC HT | 0 | 0 |
| 2.70 | Anhydrous Milk Fat | 99.8 | 2.69 |
| 4.90 | Sodium Caseinate | 1.5 | 0.073 |
| 0.45 | Soya Lecithin | 99.2 | 0.45 |
| 0.03 | Vanillin | 0 | 0 |
| 0.03 | Sucralose | 0 | 0 |
| 5.0 | Calcium Carbonate | 0 | 0 |
| 0.03 | Natural Milk | 0 | 0 |
| | Flavoring | | |
| 0.39 | Mineral Blend | 0 | 0 |
| 1.0 | Chocolate Flavoring | 0 | 0 |

### Example 3

Another low sugar chocolate composition was formed using the process in Example 1 with the following ingredients:

TABLE 3

| | | Wt. % Fat in | |
|---|---|---|---|
| Wt. % Ingredient | Ingredient | Ingredient | Wt. % Fat in Mix |
| 40.83 | Isomalt | 0 | 0 |
| 6.54 | Erythritol | 0 | 0 |
| 3.59 | Inulin LC HT | 0 | 0 |
| 30.92 | Fracto 94L* | 100 | 30.92 |
| 12.48 | Cocoa Powder | 11 | 1.37 |
| 3.54 | Inulin F97 | 0 | 0 |
| 0.73 | Cote HI** | 100 | 0.73 |
| 0.02 | Sucralose | 0 | 0 |
| 0.11 | Vanilla | 0 | 0 |
| 0.48 | Soya Lecithin | 99.2 | 0.48 |
| 0.05 | Salt | 0 | 0 |
| 0.77 | Anhydrous Milk Fat | 99.8 | 0.77 |

*Fracto 94L is a fractionated palm kernel oil with a melting point of 94 degrees and is commercially available from Cargill, Inc.
**Cote HI is partially hydrogenated palm oil.

### Example 4

Another low sugar chocolate composition was formed using the process in Example 1 with the following ingredients:

TABLE 4

| | | Wt. % Fat in | |
|---|---|---|---|
| Wt. % Ingredient | Ingredient | Ingredient | Wt. % Fat in Mix |
| 42.41 | Cocoa Liquor | 54 | 22.90 |
| 10.60 | Cocoa Butter | 100 | 10.60 |
| 11.11 | Erythritol | 0 | 0 |
| 5.55 | Inulin F97 | 0 | 0 |
| 0.49 | Soya Lecithin | 99.2 | 0.48 |
| 0.02 | Vanillin | 0 | 0 |
| 0.03 | Ace-K* | 0 | 0 |
| 0.01 | Sucralose | 0 | 0 |
| 22.21 | Isomalt | 0 | 0 |
| 5.55 | Inulin LC HT | 0 | 0 |
| 2.02 | Anhydrous Milk Fat | 99.8 | 2.02 |

*Ace-K is acesulfame-potassium commercially available from Sunnett.

### Example 5

Another low sugar chocolate composition was formed using the process in Example 1 with the following ingredients:

TABLE 5

| | | Wt. % Fat in | |
|---|---|---|---|
| Wt. % Ingredient | Ingredient | Ingredient | Wt. % Fat in Mix |
| 18.13 | Cocoa Liquor | 54 | 9.79 |
| 21.47 | Cocoa Butter | 100 | 21.47 |
| 23.57 | Erythritol | 0 | 0 |
| 11.33 | Inulin LC HT | 0 | 0 |
| 2.72 | Anhydrous Milk Fat | 99.8 | 2.71 |
| 4.93 | Sodium Caseinate | 1.5 | 0.07 |
| 0.45 | Soya Lecithin | 99.2 | 0.45 |
| 0.03 | Vanillin | 0 | 0 |
| 0.03 | Sucralose | 0 | 0 |
| 5.0 | Calcium Carbonate | 0 | 0 |
| 1.0 | Natural Chocolate | 0 | 0 |
| | Flavoring | | |
| 0.03 | Natural Milk | 0 | 0 |
| | Flavoring | | |
| 11.33 | Inulin F97 | 0 | 0 |

### Example 6

Another low sugar chocolate composition was formed using the process in Example 1 with the following ingredients:

TABLE 6

| | | Wt. % Fat in | |
|---|---|---|---|
| Wt. % Ingredient | Ingredient | Ingredient | Wt. % Fat in Mix |
| 42.41 | Cocoa Liquor | 54 | 22.90 |
| 10.54 | Cocoa Butter | 100 | 10.54 |
| 20.2 | Erythritol | 0 | 0 |
| 12.12 | Inulin F97 | 0 | 0 |
| 0.50 | Soya Lecithin | 99.2 | 0.48 |
| 0.02 | Vanillin | 0 | 0 |
| 0.03 | Ace-K | 0 | 0 |
| 0.01 | Sucralose | 0 | 0 |
| 2.08 | Anhydrous Milk Fat | 99.8 | 2.08 |
| 12.12 | Inulin LC HT | 0 | 0 |

### Example 7

Another low sugar chocolate composition was formed using the process in Example 1 with the following ingredients:

TABLE 7

| | | Wt. % Fat in | |
|---|---|---|---|
| Wt. % Ingredient | Ingredient | Ingredient | Wt. % Fat in Mix |
| 18.11 | Cocoa Liquor | 54 | 9.78 |
| 21.46 | Cocoa Butter | 100 | 21.46 |
| 6.53 | Erythritol | 0 | 0 |
| 3.45 | Inulin F97 | 0 | 0 |
| 3.45 | Inulin LC HT | 0 | 0 |
| 2.72 | Anhydrous Milk Fat | 99.8 | 2.71 |
| 3.12 | Sodium Caseinate | 1.5 | 0.05 |
| 0.45 | Soya Lecithin | 99.2 | 0.50 |
| 0.03 | Vanillin | 0 | 0 |
| 0.03 | Sucralose Powder | 0 | 0 |
| 4.98 | Calcium Carbonate | 0 | 0 |
| 1.0 | Natural Chocolate | 0.37 | 0.004 |
| | Flavoring | | |
| 0.03 | Natural Milk | 0 | 0 |
| | Flavoring | | |
| 34.64 | Isomalt | 0 | 0 |

### Example 8

Another low sugar chocolate composition was formed using the process in Example 1 with the following ingredients:

TABLE 8

| | | Wt. % Fat in | |
|---|---|---|---|
| Wt. % Ingredient | Ingredient | Ingredient | Wt. % Fat in Mix |
| 40.22 | Isomalt | 0 | 0 |
| 6.44 | Erythritol | 0 | 0 |
| 3.5 | Inulin LC HT | 0 | 0 |
| 3.5 | Inulin F97 | | |
| 31.0 | Fracto 94L | 100 | 31.0 |
| 6.53 | Cocoa Powder | 11 | 0.72 |
| 6.32 | Sodium Caseinate | 1.5 | 0.1 |
| 0.72 | Cote Hi | 100 | 0.72 |
| 0.02 | Sucralose | 0 | 0 |
| 0.11 | Vanilla | 0 | 0 |
| 0.08 | Natural Milk | 0 | 0 |
| | Flavoring | | |
| 0.05 | Salt | 0 | 0 |
| 0.47 | Soya Lecithin | 99.2 | 0.47 |
| 1.09 | Natural Chocolate | 0.37 | 0.004 |
| | Flavoring | | |

### Example 9

Another low sugar chocolate composition was formed using the process in Example 1 with the following ingredients:

TABLE 9

| | | Wt. % Fat in | |
|---|---|---|---|
| Wt. % Ingredient | Ingredient | Ingredient | Wt. % Fat in Mix |
| 29.0 | Isomalt | 0 | 0 |
| 6.37 | Erythritol | 0 | 0 |
| 3.45 | Inulin LC HT | 0 | 0 |
| 31.57 | Fracto 94L | 100 | 31.57 |
| 6.45 | Cocoa Powder | 11 | 0.71 |
| 12.70 | Sodium Caseinate | 1.5 | 0.19 |
| 0.71 | Cote Hi | 100 | 0.71 |
| 0.02 | Sucralose | 0 | 0 |
| 4.30 | Whey Protein | 4.3 | 0.19 |
| | Concentrate | | |
| 0.45 | Artificial Vanilla | 0 | 0 |
| | Flavoring | | |
| 3.45 | Inulin F97 | 0 | 0 |
| 0.47 | Soya Lecithin | 99.2 | 0.47 |
| 1.08 | Natural Chocolate | 0.37 | 0.004 |
| | Flavoring | | |

### Example 10

Another low sugar chocolate composition was formed using the process in Example 1 with the following ingredients:

TABLE 10

| | | Wt. % Fat in | |
|---|---|---|---|
| Wt. % Ingredient | Ingredient | Ingredient | Wt. % Fat in Mix |
| 31.74 | Fracto 94L | 100 | 31.74 |
| 9.92 | Inulin F97 | 0 | 0 |
| 9.92 | Inulin LC HT | 0 | 0 |
| 19.84 | Erythritol | 0 | 0 |
| 5.95 | Cocoa Powder | 11 | 0.66 |
| 19.84 | Calcium Caseinate | 0.9 | 0.18 |
| 0.99 | Cote Hi | 100 | 0.99 |
| 0.40 | Vanilla | 0 | 0.0 |
| 0.99 | Natural Chocolate | 0.37 | 0.004 |
| | Flavoring | | |
| 0.40 | Soya Lecithin | 99.2 | 0.39 |
| 0.02 | Sucralose | 0 | 0 |

### Example 11

Another low sugar chocolate composition for use in applications such as ice cream coatings was formed using the process in Example 1 with the following ingredients:

TABLE 11

| | | Wt. % Fat in | |
|---|---|---|---|
| Wt. % Ingredient | Ingredient | Ingredient | Wt. % Fat in Mix |
| 51.52 | CS 90/10L* | 100 | 51.52 |
| 17.60 | Erythritol | 0 | 0 |
| 8.80 | Inulin F97 | 0 | 0 |
| 8.80 | Inulin LC HT | 0 | 0 |
| 4.40 | Cocoa Liquor | 54 | 2.38 |
| 7.63 | Cocoa Powder | 11 | 0.84 |
| 0.88 | Calcium Caseinate | 0.9 | 0.008 |
| 0.29 | Soya Lecithin | 99.2 | 0.29 |
| 0.06 | Vanillin | 0 | 0 |
| 0.04 | Ace-K | 0 | 0 |

*CS 90/10L is a 90:10 blend of coconut and soybean oils commercially available from Cargill, Inc.

### Example 12

Another low sugar chocolate composition for use in applications such as ice cream coatings was formed using the process in Example 1 with the following ingredients:

TABLE 12

| | | Wt. % Fat in | |
|---|---|---|---|
| Wt. % Ingredient | Ingredient | Ingredient | Wt. % Fat in Mix |
| 53.29 | CS 90/10L | 100 | 53.29 |
| 19.0 | Erythritol | 0 | 0 |
| 9.50 | Inulin F97 | 0 | 0 |
| 9.50 | Inulin LC HT | | 0 |
| 1.90 | Cocoa Liquor | 54 | 1.03 |
| 3.17 | Cocoa Powder | 11 | 0.35 |
| 3.17 | Calcium Caseinate | 0.9 | 0.03 |
| 0.32 | Soya Lecithin | 99.2 | 0.31 |
| 0.06 | Vanillin | 0 | 0 |
| 0.06 | Natural Milk | 0 | 0 |
| | Flavoring | | |
| 0.04 | Ace-K | 0 | 0 |

### Example 13

Another low sugar chocolate composition was formed using the process in Example 1 with the following ingredients:

TABLE 13

| | | Wt. % Fat in | |
|---|---|---|---|
| Wt. % Ingredient | Ingredient | Ingredient | Wt. % Fat in Mix |
| 18.11 | Cocoa Liquor | 54 | 9.78 |
| 21.46 | Cocoa Butter | 100 | 21.46 |
| 6.53 | Erythritol | 0 | 0 |
| 3.45 | Inulin F97 | 0 | 0 |
| 3.45 | Inulin LC HT | 0 | 0 |
| 2.72 | Anhydrous Milk Fat | 99.8 | 2.71 |
| 3.12 | Calcium Caseinate | 1.5 | 0.05 |
| 0.45 | Soya Lecithin | 99.2 | 0.45 |
| 0.03 | Vanillin | 0 | 0 |
| 0.03 | Sucralose | 0 | 0 |
| 4.98 | Calcium Carbonate | 0 | 0 |
| 1.0 | Natural Chocolate | 0.37 | 0.004 |
| | Flavoring | | |
| 0.03 | Natural Milk | 0 | 0 |
| | Flavoring | | |
| 34.64 | Isomalt | 0 | 0 |

### Example 14

A low sugar chocolate composition was formed using the following procedure. Erythritol, cocoa mass, 5-10% cocoa butter and inulin were mixed and kneaded for ten to fifteen minutes at 30-40 degrees Celsius in a mixer. The mass was refined by milling it on a cooled five-roll refiner to provide a smooth fluid paste. The mass was conched at 80 degree Celsius for 16-22 hours. Near the end of the conching period, the remaining cocoa butter and the lecithin were added (e.g., for a 16 hour conching time, the remaining cocoa butter would be added after 14 hours and the lecithin after 15 hours). To increase the sweetness, an intensity sweetener was also added. Next, the mass was tempered at 28-31 degrees Celsius. Finally, the mass was poured into moulds to set or use in an enrobing process to produce chocolate coated-confectionery.

TABLE 14

| | | Wt. % Fat in | |
|---|---|---|---|
| Wt. % Ingredient | Ingredient | Ingredient | Wt % Fat in Mix |
| 26.4 | Erythritol | 0 | 0 |
| 17.6 | Inulin | 0 | 0 |
| 42.0 | Cocoa Liquor | 54 | 22.7 |
| 13.5 | Cocoa Butter | 100 | 13.5 |
| 0.48 | Lecithin | 99.2 | 0.48 |
| 0.02 | Vanilla | 0 | 0 |

### Example 15

Glycemic Index (“GI”) is defined as “the incremental area under the blood glucose response curve of a 50 g carbohydrate portion of a test food expressed as a percentage of the response to the same amount of carbohydrate from a standard food taken by the same subject” (Food and Agricultural Organization (1998), FAO Food and Nutrition Paper No. 66, Food and Agriculture, Rome, Italy). The standard food commonly used is glucose in water, and the GI is expressed relative to glucose where glucose is assigned a GI of 100.

More specifically, the glycemic index is defined as the incremental area under the blood glucose response curve of a 50 g carbohydrate portion of a test food expressed as a percent of the response to the same amount of carbohydrate from a standard food taken by the same subject. Some of the terms are discussed below because the methods used to determine the glycemic index of foods and to apply the information to diets may profoundly affect the results obtained.

The insulinemic index (“InsI”) of a test food is determined under the same conditions as those for the GI, replacing the measurement of glucose levels with that of insulin levels. The InsI is defined as the incremental area under the blood insulin response curve of a 50 g carbohydrate portion of a test food expressed as a percent of the response to the same amount of carbohydrate from a standard food taken by the same subject.

### Incremental Area Under the Curve

A number of different methods have been used to calculate the area under the curve. For most glycemic index data, the area under the curve has been calculated as the incremental area under the blood glucose response curve (IAUC), ignoring the area beneath the fasting concentration. This can be calculated geometrically by applying the trapezoid rule. When a blood glucose value falls below the baseline, only the area above the fasting level is included. Sample data are shown in Table 15.

TABLE 15
Sample blood glucose responses to the ingestion of
50 g carbohydrate

| | Minutes | | | | | | | |
|---|---|---|---|---|---|---|---|---|
| | 0 | 15 | 30 | 45 | 60 | 90 | 120 | IAUC |
| Standard #1 | 4.3 | 6.3 | 7.9 | 5.3 | 4.1 | 4.6 | 4.9 | 114 |
| Standard #2 | 4.0 | 6.0 | 6.7 | 5.5 | 5.3 | 5.0 | 4.2 | 155 |
| Standard #3 | 4.1 | 5.8 | 8.0 | 6.5 | 5.9 | 4.8 | 3.9 | 179 |
| Test Food | 4.0 | 5.0 | 5.8 | 5.4 | 4.8 | 4.2 | 4.4 | 93 |

### 50 g Carbohydrate Portion

The portion of food tested should contain 50 g of glycemic (available) carbohydrate. In practice, glycemic carbohydrate is often measured as total carbohydrate minus dietary fiber, as determined by the AOAC method. Since this method does not include RS 1 and RS 2 when they are present, they will be mistakenly included as glycemic carbohydrate.

### Blood Glucose Response

This is normally measured in capillary whole blood. Plasma glucose can be used to determine the glycemic index and gives similar values. However, capillary blood is preferred because it is easier to obtain, the rise in blood glucose is greater than in venous plasma and the results for capillary blood glucose are less variable than those for venous plasma glucose. Thus, differences between foods are larger and easier to detect statistically using capillary blood glucose.

### Same Subject

Blood glucose responses can vary considerably from day-today within subjects. Thus, to obtain a representative mean response to the standard food, it is recommended that the standard food be repeated at least three times in each subject. This is illustrated by the data in Table 15, which is typical for normal subjects. The standard food was repeated three times giving IAUCs of: 114, 155 and 179. The mean ±SD IAUC is 149±33 and the coefficient of variation (100× SD/mean) is 22%. For this subject, the GI of the test food=100×93/149=62.

Each of the examples and embodiments in this application are presented to illustrate the present invention and to assist one of ordinary skill in making and using the same. The examples and embodiments are not intended in any way to otherwise limit the scope of the invention. While the invention has been described with reference to various specific and illustrative embodiments and techniques, it should be understood that many variations and modifications may be made while remaining within the spirit and scope of the invention.

What is claimed is:

1. A confectionery composition comprising at least about 25 wt. % fat and at least about 5 wt. % of an erythritol/FOS combination;
wherein the erythritol/FOS combination includes erythritol and an FOS component; and the FOS component includes at least about 25 wt. % fructo-oligosaccharide having a DP greater than 20 and at least about 50 wt. % fructo-oligosaccharide having a DP less than 20.

2. The composition of claim 1 wherein the erythritol/FOS combination has an erythritol/fructo-oliggosaccharide weight ratio of about 30:70 to about 70:30.

3. The composition of claim 1 wherein said composition has a glycemic index of no more than about 15.

4. The composition of claim 1 wherein said composition has an insulinemic index of no more than about 15.

5. The composition of claim 1 further comprising isomalt.

6. The composition of claim 5 wherein the amount of the isomalt is no more than about 50 wt. % of the total amount of non-fat components present in the composition.

7. The composition of claim 1 wherein said composition has substantially no cooling effect when eaten.

8. The composition of claim 1 further comprising a texture and mouth feel enhancer selected from the group consisting of food protein, food polymer carbohydrates, and mixtures thereof.

9. The composition of claim 1 wherein the fat includes cocoa butter, fractionated palm kernel oil, partially hydrogenated palm kernel oil, partially hydrogenated cottonseed oil, partially hydrogenated soybean oil, partially hydrogenated palm oil, or a mixture thereof.

10. The composition of claim 1 comprising the cocoa butter, palm oil, shea oil, or a mixture thereof.

11. The composition of claim 1 wherein said composition is an ice cream coating and the fat comprises cocoa butter, coconut oil, soybean oil, partially hydrogenated coconut oil, peanut oil, partially hydrogenated soybean oil, fractionated soybean oil, fractionated palm oil, fractionated shea oil, or a mixture thereof.

12. The composition of claim 1 wherein the composition comprises about 5-15 wt. % erythritol and about 5-15 wt. % of the FOS component, and further comprises about 20-45 wt. % isomalt.

13. The composition of claim 1 further comprising polydextrose.

14. The composition of claim 1 further comprising a high protein material.

15. The composition of claim 14 wherein the high protein material includes casein, whey protein, milk protein, pea protein, soy protein, gelatin, mixtures thereof, or processed forms thereof.

16. The composition of claim 1 further comprising a calcium source.

17. A confectionery composition comprising at least about 25 wt. % fat and at least about 35 wt. % of an erythritol/FOS combination;
wherein the erythritol/FOS combination includes an erythritol and an FOS component in a weight ratio of about 30:70 to about 70:30.

18. The composition of claim 17 wherein the FOS component includes at least about 25 wt. % fructo-oligosaccharide having a DP greater than 20 and at least about 50 wt. % fructo-oligosaccharide having a DP no more than 20.

19. The composition of claim 17 comprising at least about 30 wt. % cocoa liquor.

20. The composition of claim 17 having a total fat content of about 30 to 45 wt. %; and further comprising at least about 15 wt. % cocoa solids.

21. The composition of claim 17 wherein said composition has a glycemic index of no more than about 15.

22. The composition of claim 17 wherein said composition has a insulinemic index of no more than about 15.

23. The composition of claim 17 comprising about 30 to 45 wt. % cocoa butter.

24. The composition of claim 17 further comprising polydextrose.

25. The composition of claim 17 further comprising isomalt.

26. A confectionery composition comprising at least about 25 wt. % fat and at least about 35 wt. % of an erythritol/FOS combination;
wherein the erythritol/FOS combination comprises erythritol and an FOS component which includes at least about 25 wt. % fructo-oligosaccharide having a DP greater than 20 and at least about 50 wt. % fructo-oligosaccharide having a DP less than 20.

27. The composition of claim 26 wherein said composition has a glycemic index of no more than about 15.

28. The composition of claim 26 wherein said composition has an insulinemic index of no more than about 15.

29. The composition of claim 26 comprising at least about 10 wt. % erythritol and at least about 10 wt. % of the FOS component.

30. The composition of claim 26 having a total fat content comprising about 30 to 45 wt. % cocoa butter, and further comprising about 15 wt. % cocoa solids.

31. A confectionery composition comprising erythritol, an FOS component, and at least about 25 wt. % fat;
wherein said composition has a glycemic index of no more than about 15; and the FOS component includes at least about 25 wt. % FOS having a DP greater than 20 and at least about 50 wt. % FOS having a DP less than 20.

32. The composition of claim 31 wherein the glycemic index is no more than about 5.

33. The composition of claim 31 further comprising at least about 5 wt. % of a combination of erythritol and the FOS component, wherein said composition includes the erythritol and the FOS component in a weight ratio of about 70:30 to about 30:70.

34. The composition of claim 31 comprising at least about 10 wt. % erythritol and at least about 10 wt. % of the FOS component.

35. A confectionery composition comprising isomalt, erythritol, an FOS component, and at least about 25 wt. % fat;
wherein the total amount of the isomalt, the erythritol, and the FOS component is at least about 30 wt. % of the composition; and the FOS component includes at least about 25 wt. % fructo-oligosaccharide having a DP greater than 20 and at least about 50 wt. % fructo-oligosaccharide having a DP less than 20.

36. The sweetening composition of claim 35 comprising at least about 5 wt. % of a combination of erythritol and the FOS component;
wherein said composition has a glycemic index of no more than about 5 and includes the erythritol and the FOS component in a weight ratio of about 70:30 to about 30:70.

37. The composition of claim 35 wherein the composition comprises about 5-15 wt. % erythritol and about 5-15 wt. % of the FOS component, and further comprises about 20-45 wt. % isomalt.

38. A confectionery composition comprising at least about 5 wt. % isomalt, at least about 25 wt. % fat, and at least about 5 wt. % of an erythritol/FOS combination;
wherein the erythritol/FOS combination includes at least about 30 wt. % erythritol and at least about 30 wt. % of an FOS component; and the FOS component includes at least about 25 wt. % fructo-oligosaccharide having a DP greater than 20 and at least about 50 wt. % fructo-oligosaccharide having a DP less than 20.

39. The composition of claim 38 wherein said composition is a chocolate composition comprising at least about 30 wt. % cocoa butter.

40. The composition of claim 38 wherein the composition comprises about 5-15 wt. % erythritol and about 5-15 wt. % of the FOS component, and further comprises about 20-45 wt. % isomalt.

41. The composition of claim 38, wherein said composition has a glycemic index of no more than about 15.

42. The composition of claim 38 wherein said composition has an insulinemic index of no more than about 15.

43. A chocolate composition substantially free of sucrose, which comprises a cocoa component, and a sweetener component;
wherein the cocoa component comprises cocoa butter and cocoa solids, and the sweetener component comprises erythritol and an FOS component;
wherein the FOS component includes at least about 25 wt. % fructo-oligosaccharide having a DP greater than 20 and at least about 50 wt. % fructo-oligosaccharide having a DP less than 20; and
wherein the total fat content of the chocolate composition is about 30 to 45wt. %.

44. The composition of claim 43 further comprising a milk solids component.

45. The composition of claim 43 wherein the sweetener component includes the erythritol and the FOS component in a weight ratio of about 70:30 to about 30:70.

46. The composition of claim 43 comprising at least about 15 wt. % of the erythritol component and at least about 15 wt. % of the FOS.

47. The composition of claim 43 comprising about 30-45 wt. % cocoa butter and at least about 15 wt. % cocoa solids;
wherein said composition has a glycemic index of no more than about 15.

48. A confectionery composition comprising erythritol, an FOS component, and at least about 25 wt. % fat;
wherein said composition has an insulinemic index of no more than about 15; and the FOS component includes at least about 25 wt. % fructo-oligosaccharide having a DP greater than 20 and at least about 50 wt. % fructo-oligosaccharide having a DP less than 20.

49. The composition of claim 48 wherein the insulinemic index is no more than about 5.

50. A sweetening composition comprising erythritol and an FOS component, wherein said composition has a glycemic index of no more than about 15; and
the FOS component includes at least about 25 wt. % fructo-oligosaccharide having a DP greater than 20 and at least about 50 wt. % fructo-oligosaccharide having a DP less than 20.

51. The sweetening composition of claim 50 wherein said composition has a glycemic index of no more than about 5.

52. The sweetening composition of claim 50 comprising at least about 30 wt. % erythritol and at least about 30 wt. % of the FOS component.

53. The sweetening composition of claim 50 further comprising isomalt.

54. The sweetening composition of claim 50 wherein the weight ratio of the erythritol to the FOS component is about 30:70 to about 70:30.

55. The sweetening composition of claim 50 comprising at least about 5 wt. % of a combination of erythritol and the FOS component;
wherein the weight ratio of the erythritol to the FOS component is about 55:45 to about 40:60; and
said composition has a glycemic index of no more than about 5.

56. The sweetening composition of claim 57 wherein said composition contains no more than about 0.5 wt. % total monosaccharide and disaccharide components.

57. A sweetening composition comprising erythritol and an FOS component, wherein said composition has an insulinemic index of no more than about 15; and
wherein the FOS component includes at least about 25 wt. % fructo-oligosaccharide having a DP greater than 20 and at least about 50 wt. % fructo-oligosaccharide having a DP less than 20.

58. The sweetening composition of claim 57 wherein said composition has a insulinemic index of no more than about 5.

59. The sweetening composition of claim 57 comprising at least about 5 wt. % of a combination of erythritol and the FOS component;
wherein the weight ratio of the erythritol to the FOS component is about 55:45 to about 40:60.

60. The sweetening composition of claim 57 comprising at least about 30 wt. % erythritol and at least about 30 wt. % of the FOS component.

61. The sweetening composition of claim 57 further comprising isomalt.

62. The sweetening composition of claim 57 wherein the weight ratio of the erythritol to the FOS component is about 30:70 to about 70:30.

63. The sweetening composition of claim 57 wherein said composition contains no more than about 0.5 wt. % total monosaccharide and disaccharide components.
